(19) United States
(12) Patent Application Publication
(10) Pub. No.: US 2025/0310395 A1
(43) Pub. Date: Oct. 2, 2025

(54) COLLABORATIVE WEB BROWSING DURING VIDEO CONFERENCES

(71) Applicant: Zoom Video Communications, Inc., San Jose, CA (US)

(72) Inventors: Evgeny Balashov, Burbank, CA (US); Christopher Allen Alexander Goodine, Westport (CA); Arun Janakiraman, San Francisco, CA (US); Ross Douglas Mayfield, Palo Alto, CA (US)

(73) Assignee: Zoom Video Communications, Inc., San Jose, CA (US)

(21) Appl. No.: 18/621,878

(22) Filed: Mar. 29, 2024

(51) Int. Cl. H04L 67/02; H04L 65/403

(52) U.S. Cl. CPC H04L 67/02; H04L 65/403

(57) ABSTRACT

Techniques for collaborative web browsing during video conferences are disclosed. In an example method, a client device joins a video conference including a number of client devices. The client device executes a command to start a collaborative web browsing session using a web browser. The client device receives a first indication of a first web browsing action associated with a first web page by another client device. The client device outputs a first representation of the first action on the first page. The client device receives a second indication of a second web browsing action associated with a second web page by the other client device, in which the second action modifies the first representation of the first action. The client device outputs a second representation of the second action on the second page based on the modification to the first representation of the first action.

### FIELD

The present application generally relates to collaboration during video conferencing, and more particularly relates to techniques for collaborative web browsing during video conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for techniques for collaborative web browsing during video conferences, according to some aspects of the present disclosure.

FIG. 4 shows an example of a system implementing techniques for collaborative web browsing during video conferences, according to some aspects of the present disclosure.

FIG. 5 shows an illustration of a user interface (UI) of a web browser application for collaborative web browsing during video conferences, according to some aspects of the present disclosure.

FIG. 6 shows another illustration of a UI of a web browser application for collaborative web browsing during video conferences, according to some aspects of the present disclosure.

FIG. 7 shows a flowchart of an example method for collaborative web browsing during video conferences, according to some aspects of the present disclosure.

FIG. 8 shows a flowchart of another example method for collaborative web browsing during video conferences, according to some aspects of the present disclosure.

FIG. 9 shows an example computing device suitable for use in example systems or methods for providing techniques for collaborative web browsing during video conferences, according to some aspects of the present disclosure.

### DETAILED DESCRIPTION

Examples are described herein in the context of techniques for collaborative web browsing during video conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

The use cases for video conferencing have grown beyond simple spoken communication to include rich forms of collaborative interaction. For example, client software for video conferencing can enable video conference participants to achieve greater heights of productivity through the incorporation of other applications into the video conferencing experience. Such applications can be used for collaboration during a video conference to maximize the utility of the video conferencing medium.

Video conference client software may include screen sharing capabilities. During screen sharing, a number of video conference participants can view the actions of another video conference participant using an application such as a web browser. For instance, a first participant who is sharing their screen may open a webpage as a basis or reference for an ongoing discussion. The video conference participants can then view the webpage while observing the actions of the first participant or directing the first participant. Collaborative browsing through screen sharing is a passive, constrained experience, however, because it is not truly collaborative since only one participant can interact with the webpage at a time.

Additionally, collaboration using screen sharing means that only one webpage or tab can be viewed at a time by participants. If a participant who is not sharing their screen during web browsing navigates to a different webpage in their local browser, their actions and viewpoint cannot be seen by other participants without shifting the screen sharing viewpoint to the participant. Shifting the screen sharing viewpoint can be slow and disruptive. These and other disadvantages, taken together, can make collaboration using screen sharing during a video conference a poor user experience.

These difficulties can be addressed using the techniques for collaborative web browsing during video conferences disclosed herein. The following non-limiting example is provided to introduce certain concepts. Consider a product team meeting to brainstorm ideas for a new product. The team may desire to tour a competitor's product line together. A first client device used by a member of the product team joins a video conference hosted by a video conference provider along with a number of other client devices in use by other members of the product team.

In response to a selection made by the team member, the first client device executes a command to start a collaborative web browsing session among the client devices in use by the product team using a web browsing application such as an embedded web browser in the video conference client software. A collaborative web browsing session generally enables participants to continue to browse the web independently while simultaneously and in real-time monitoring the actions of other participants through various UI mechanisms.

However, during the collaborative web browsing session, each team member can choose to follow the actions of other team members, similarly to the passive user experience during screen sharing, using functionality such as “follow” and “spotlight” functions. In these cases, the following users or users viewing other spotlit users may observe the content seen by and the interactions of other users, with only none or a limited subset of web browser interactivity available. Some features of the present disclosure can lead to an enhanced user experience in both of these cases.

To facilitate this, the first client device receives indications of web browsing actions taken by a second client device used by another team member. The first client device outputs representations of the actions of the second client device, in which the representations convey the actions of the second client device to the team member using the first client device. For example, if the first client device is browsing a first web page and the second client device is browsing a second web page, the web browser shown on the display of the first client device may show an icon on another tab, indicating that the second client device is browsing the second web page. In another example, the first client device and the second client device may be browsing the same web page. In that case, the actions of the team member using the second client device, such as mouse movements and clicks, may be visible on the display of the first client device.

The innovations of the present disclosure provide significant improvements in the technical field of collaboration during video conferencing. As described above, existing approaches limited collaborative web browsing during video conferences to passive, one-way screen sharing which resulted in a poor user experience. The techniques disclosed herein enable an interactive, fully collaborative mode of web browsing that can result in an improved user experience including capabilities such as simultaneous browsing of different web pages, user interface elements that convey the actions of other collaborators, spotlighting and following features, and so on.

In addition to the improvements in user experience, the techniques described herein can improve the functioning of computers through reduced consumption of computing resources. Because collaborative efforts can be performed in parallel, duplicative browsing may be reduced, reducing overall load on the networks. Similarly, because the workload associated with collaborative browsing tasks can now be spread across multiple client devices operating in parallel, the computational demand on the single client device used in the screen sharing paradigm may be reduced. The improved collaborative methods enabled herein also may reduce the length of video conferences overall, boosting productivity and reducing costs, but also reducing the consumption of computing and network resources through shorter and more efficient video conferences.

These illustrative examples are given to introduce the reader to the general subject matter discussed herein and the disclosure is not limited to these examples. The following sections describe various additional non-limiting examples of techniques for collaborative web browsing during video conferences.

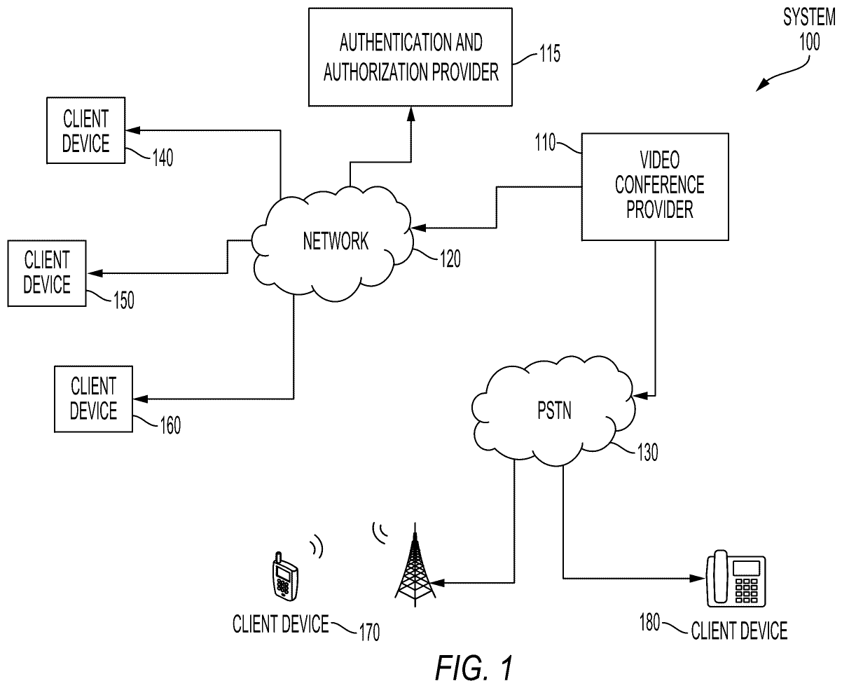

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

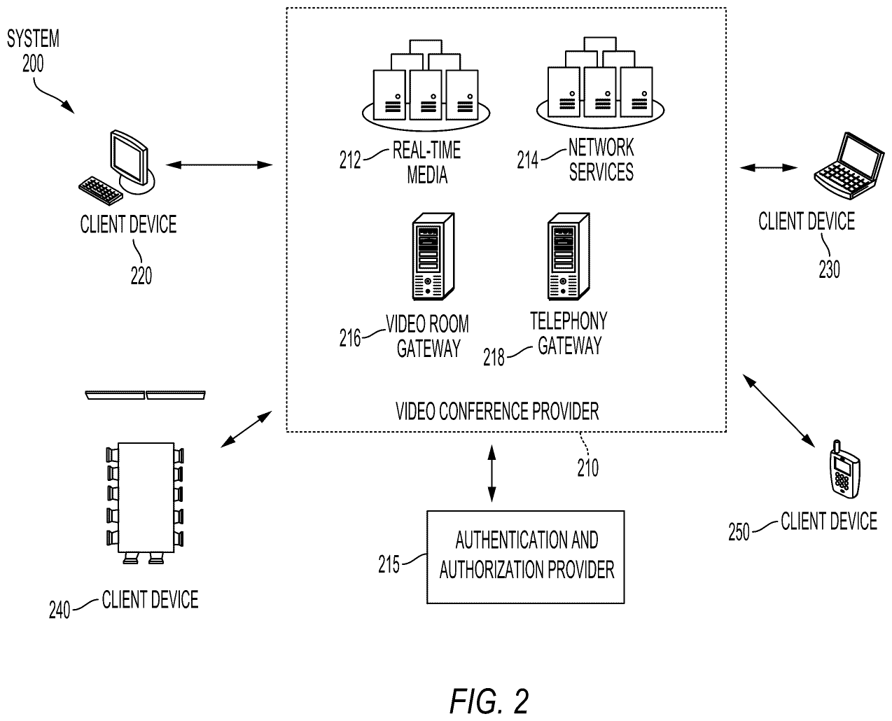

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

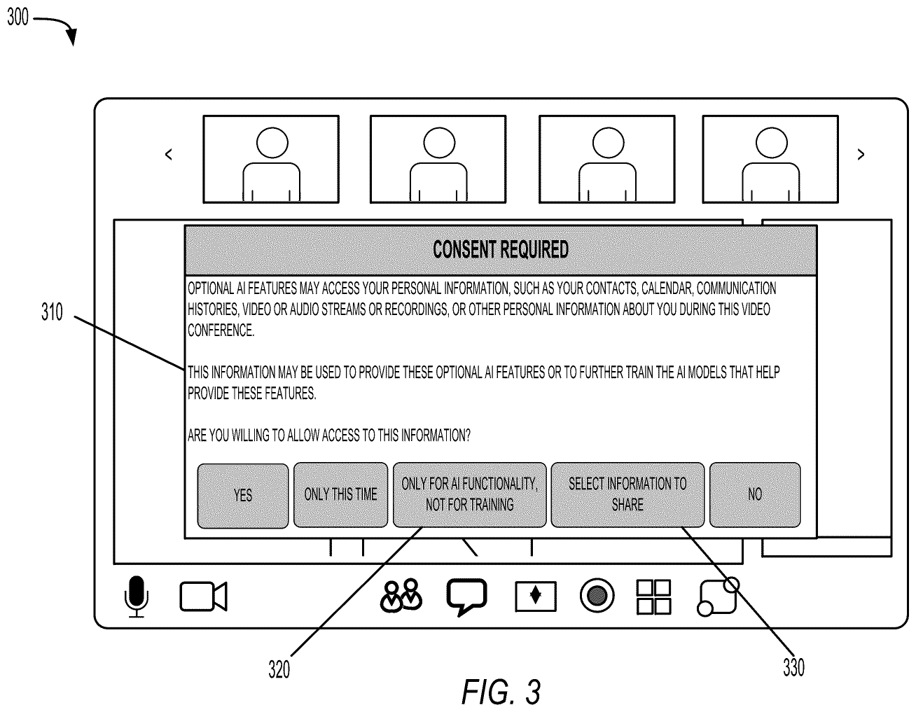

Turning next to FIG. 3, FIG. 3 shows an example user interface 300 that may be used in some example systems configured for collaborative web browsing during video conferences. In some examples according to the present disclosure, a user may select an option to use one or more optional AI features available from the virtual conference provider 302. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

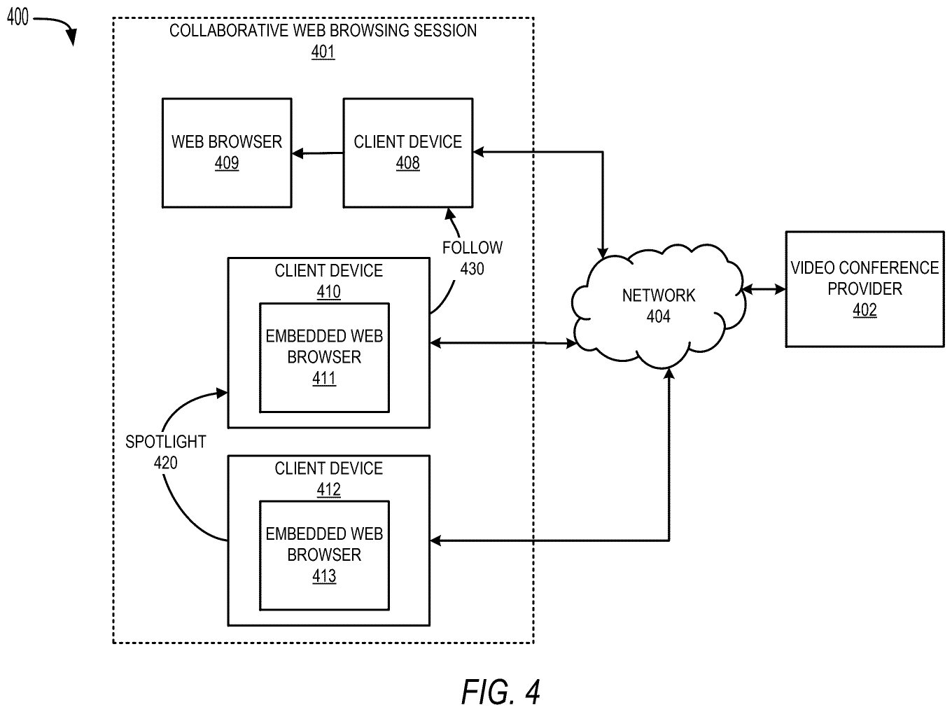

Referring now to FIG. 4, FIG. 4 shows an example of a system 400 implementing techniques for collaborative web browsing during video conferences, according to some aspects of the present disclosure. System 400 includes three client devices 408, 410, 412 communicatively coupled with video conference provider 402 over a network 404. Network 404 may include the Internet, public networks, private networks, or combinations thereof. Video conference provider 402 is typically a server or collection of servers, including a combination of privately or cloud-hosted devices. Video conference provider 402 may be similar, in some respects, to the video conference providers 110, 210 described above with respect to FIGS. 1 and 2.

Client devices 408, 410, 412 may be any type of device capable of executing the appropriate client software for collaborative web browsing during video conferences. For example, the client devices 408, 410, 412 may be laptops, desktops, smartphones, tablets, internet protocol (IP) phones, and so on. Client devices 408, 410, 412 are participants in a collaborative web browsing session 401 shown schematically with a dashed line. In some examples, the collaborative web browsing session 401 occurs during a video conference including client devices 408, 410, 412.

Collaborative web browsing during video conferences, of which collaborative web browsing session 401 is an instance of, can refer generally to a video conference client software feature that enables a number of users to simultaneously navigate, view, and interact with web content together in real time. In some examples, the collaborative web browsing session 401 can be enabled through functionality provided by video conference client software as well as integrations, plugins, addons, etc. used in concert with web browsers. Collaborative web browsing can be enabled by application components that synchronize the browsing session among the participating client devices 408, 410, 412, which can allow participants to experience shared or simultaneous control of web navigation controls, viewing of content, interaction with content,

In general, participants in a collaborative web browsing session 401 can continue use their client devices and to browse the web independently. Various UI mechanisms and indicators can be used to provide indications of the actions and locations of collaborating users. Certain modes can be entered voluntarily (e.g., follow a user) or involuntarily (e.g., host spotlights a user for all participants) that may involve loss of all or a subset of web browser functionality in favor of viewing the content and interactions of the web browser UI of the followed or spotlit device. Even in these modes, however, in some examples, some interactivity may be maintained. For instance, a followed user may still be able to see indications of the mouse cursor or UI interactions of the users following them.

For example, client devices 410, 412 are executing video conference client software that provides an embedded web browser 411, 413 as part of the video conference user interface (UI). The embedded web browser 411, 413 may be configured for collaborative web browsing using the techniques of this disclosure. Other client device configurations are possible. For example, the web browser may be a third-party integration, integrated into the video conference UI. In another example, client device 408 is using an external web browser 409 for collaborative web browsing. In addition to the examples shown in system 400, client devices 408, 410, 412 can use any suitable web browser application that is configured for collaborative web browsing, including web-based browsers, embedded browsers, desktop browsers, mobile browsers, text- or console-based browsers, virtual reality/augmented reality/mixed reality browsers, and so on.

Collaborative web browsing can refer, collectively, to a number of video conference client software or web browser features. Since client devices 408, 410, 412 are participating in collaborative web browsing session 401, collaborative features may be used to facilitate various aspects of the collaborative web browsing experience. Some examples of such features are shown in system 400, but other collaborative web browsing features, in addition to these examples, may be included. In a first example, client device 410 has been designated as the subject of spotlight 420. The spotlight 420 feature can involve highlighting or prioritizing the view and actions of a particular participant's web browser (client device 410 in this example) to all other participants in the video conference or the subset participating in the collaborative web browsing session 401. For example, the web page being viewed, content being viewed or interacted with, or web browsing actions performed by client device 410 can be output in real-time to client devices 408, 412. The client devices 408, 412 can then display the web page being viewed, content being viewed or interacted with, or web browsing actions performed by client device 410. In some examples, client devices 408, 412 may have no or limited ability to control or interact with spotlit client device 410.

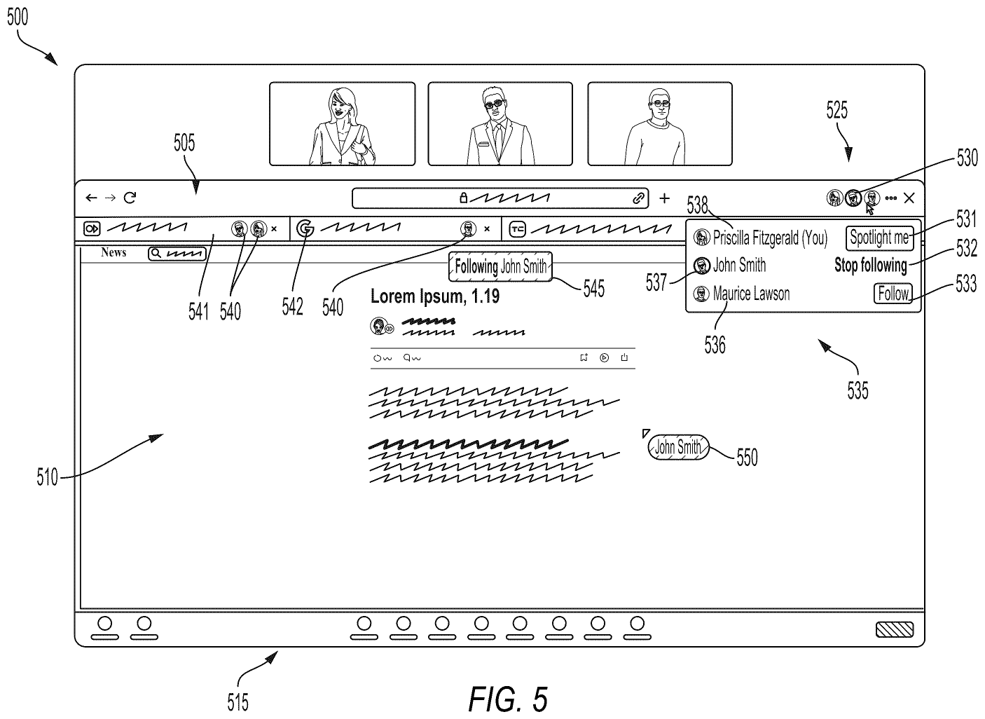

Spotlight 420 during a collaborative web browsing session 401 may involve prominently displaying or highlighting the web browsing actions of particular client device for some or all of the collaborators. For example, the web browser UI of spotlit client device 410 may consume a significant portion of the video conference client software or web browser UI on the other client devices 408, 412. In another example, the web browser UI of spotlit client device 410 may be locked in a predefined or configured position regardless of the actions of other collaborators or the actions of the other client devices. For example, the web browser UI of spotlit client device 410 may be shown, in the video conference client software or web browser UI on the other client devices 408, 412, in a participant window. The participant window may be “pinned” such that it remains in the foreground. Examples of participant windows are shown in FIG. 5 below. In another example, the web browser UI of spotlit client device 410 may be shown in another operating system window executing the web browser or a sub-process thereof. Client device 408 is the subject of a follow 430 action by client device 410. The follow 430 action is similar to the spotlight 420 action in that the web browser UI of a followed client device 408 may be highlighted, locked, or shown in a position of prominence. For example, the web browser UI of followed client device 408 may be shown, in the video conference client software or web browser UI on the other client devices 410, 412, in a participant window that may be pinned or otherwise highlighted or emphasized. In another example, the web browser UI of followed client device 408 may be shown in another operating system window. In yet another example, the web browser UI of followed client device 408 may be shown in lieu of the web browser UI of the other client devices 410, 412. Interaction with the web browser UI of followed client device 408 may be possible in this case.

In some examples, the follow 430 action differs from the spotlight 420 action in that the users of client devices 408, 410, 412 may individually determine which client devices to follow, whereas the spotlit client device 410 may be designated by another participant. For example, client devices 408, 410, 412 can select other client devices for spotlight 420 or can designate themselves as the subject of the spotlight 420. In some examples, only one client device 410 can be spotlit at a time while in other examples, multiple client devices 408, 410, 412 can be designated the subject of the spotlight 420 action. While the selection of a spotlit client device 410 may cause the web browser UI of followed client device 408 to be shown on the display of the other client devices 408, 412, it may be possible to opt out of seeing the web browser UI of a spotlit client device 410. For example, the other client devices 408, 412 may include a control to disable the spotlight. Likewise, it may be possible to un-follow a followed client device 408.

Other actions and features may be available during the collaborative web browsing session 401. For example, icons or other UI features may show the current browsing location and browsing actions of other collaborating users. Sub-collaborations may be possible using, for example, the tab features provided by some web browsers. In this feature, a portion of the collaborating group during a video conference may collaborate together on one tab while another portion of the group collaborates together on another tab.

Other features for collaborative web browsing during video conferences may include shared bookmarks, a shared history view to access previously visited pages collectively, a privacy mode for temporarily opting out of the collaborative web browsing session 401, notifications relating to the actions of other client devices, annotations or highlighting, and so on.

Turning next to FIG. 5, FIG. 5 shows an illustration of a user interface 500 of a web browser application for collaborative web browsing during video conferences, according to some aspects of the present disclosure. The user interface 500 includes elements of both a video conferencing application and a web browser. The user interface 500 is an example of the user interface 500 that may be seen by a user collaborating using a client device 408 as shown in FIG. 4.

The user interface 500 includes top browser controls 505. The top browser controls 505 may include controls typically associated with web browsers as well as some controls provided by host operating systems. For instance, the top browser controls 505 may include controls for closing or minimizing the window, back or forward buttons, reload buttons, the URL address bar, and so on. The user interface 500 also includes bottom controls 515. The bottom controls 515 may include controls for operating the video conference client software during the video conference such as audio controls, video controls, security controls, screen sharing controls, and so on.

The user interface 500 shows other participants 520 within participant windows. The participants 520 are representative of the client devices participating in the video conference. The participants 520 are also representative of the client devices participating in the collaborative web browsing session 401. The participants are also shown in a miniaturized icon view 525 which shows a representation of the client devices that can indicate which client devices are participating in the collaborative web browsing session 401 as well as the status of the participating client devices. For example, the icon view may show a follow indicator 530 to indicate that a particular client device 408 is being followed.

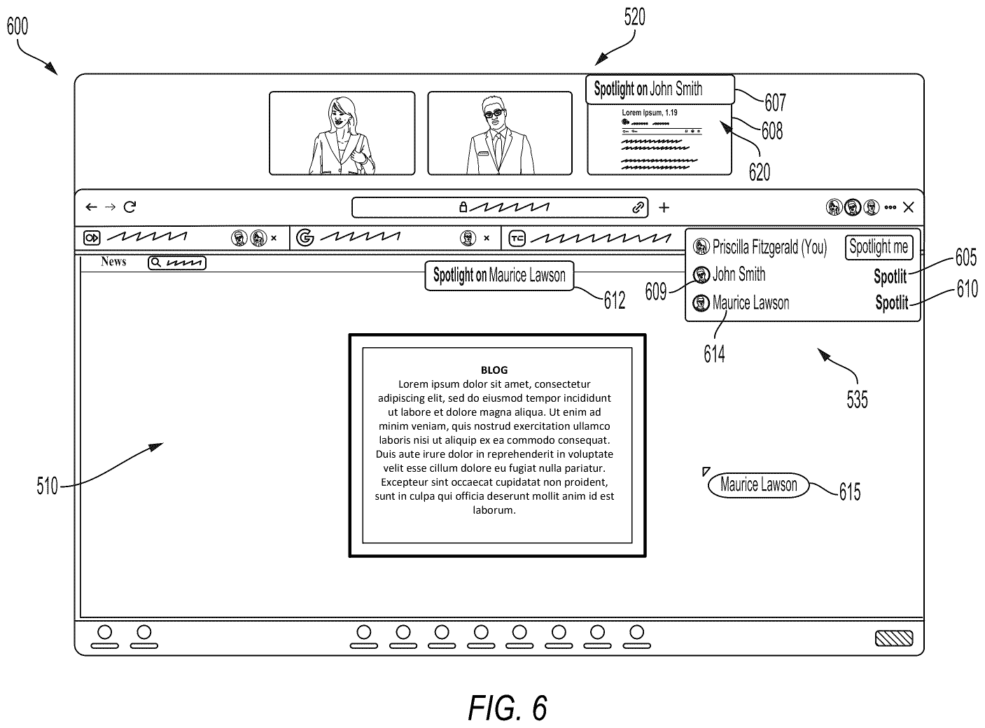

The user interface 500 includes a main browsing window 510. The main browsing window 510 may show the web page being browsed by the user of the client device 408 or the web page of another client device that is being followed or that is spotlit. An example of a user interface that may be seen when one or more users are spotlit is shown in FIG. 6. In the example shown in FIG. 5, another user is being followed using the follow 430 action as described above with respect to FIG. 4. Following indicator 545 indicates that the user of the client device 408 is following another user. The web page visible in the main browsing window 510 is representative of the browsing activity of the followed user. For example, the current mouse position of the followed user is shown by the mouse position indicator 550 in real-time. Other indications of the web browsing actions of the followed user may be shown, such as scrolling position, text selection, clicks on links or buttons, typing in form fields, or navigating to different pages or tabs. During the collaborative web browsing session 401, the followed user may reciprocally see the web browsing actions of the following user on their own web browser UI.

In addition to the follow indicator 530, the follow indicator 537 is also shown on the participant panel 535 along with a follow button 532. In this illustration, the follow button 532 has been pushed and the content of the follow button 532 has been updated to indicate that the selected user is being followed. The follow button 532 includes the text “Stop following” indicating that activating the follow button 532 will stop the following of the selected user.

The participant panel 535 can include a list of all users associated with client devices that are joined to the video conference and participating in the collaborative web browsing session 401 in the context of the video conference. The participant panel 535 includes users 536 and UI controls such as spotlight button 531, follow button 532, and follow button 533. The participant panel 535 may include a representation 538 of the user of the client device 408 (labeled “You”). The spotlight button 531 can be used to spotlight the user's own web browsing activity for all other collaborators joined to the video conference. In some examples, spotlight controls are available to select other users for spotlight.

Another collaborative web browsing feature included in some examples involves simultaneous browsing among multiple web browser tabs. Web browser tabs can refer generally to selectable windows or locations within a web browser that can allow users to open and switch between multiple websites or documents simultaneously. Typically, each tab shown in a web browser operates independently, enabling users have multiple web pages loaded and ready for interaction or viewing at a time. For example, each tab may be a separate browser sub-process. During the collaborative web browsing session 401, a number of tabs can be viewed or interacted with simultaneously. For example, a first subset of the collaborating team may be viewing or interacting with a first tab while a second subset of the collaborating team may be viewing or interacting with a second tab.

In general, each client device can freely create and move among an arbitrary number of tabs limited by memory or application constraints of the respective client devices. The user interface 500 includes tab indications 540. The tab indications 540 can indicate the tab that is currently being viewed or interacted with by other client devices. In particular, the presence of tab indications 540 can mean that the indicated client devices are browsing the respective tabs. As illustrated by tab indications 540 appearing on two tabs, the active tab 541 and another tab 542, two users are viewing the active tab 541 and one user is viewing the other tab 542. In this example, the two users viewing the active tab 541 are the user of the client device 408 and the followed user, as shown by the highlighted follow indicator 537. In some examples, a new tab created by any collaborating client device will appear on the web browser UI of all client devices participating in the collaborative web browsing session 401. In some other examples, only new tabs created by followed or spotlit client devices will appear on the web browser UI of all client devices participating in the collaborative web browsing session 401.

When the web browser UI of a spotlit or followed user is shown, such as in the example UIs 500 and 600 (described below), various examples may assign different meaning to the tabs 541, 542 shown. For example, in some implementations, the tabs 541, 542 may reflect the tabs that the spotlit or followed user has open on their respective client device. In that case, in examples in which a limited amount of interactivity is still available during spotlit or following, the tabs 541, 542 may be non-interactive UI components. In other examples, the tabs 541, 542 may be interacted with, but may disable the spotlit or following selection, since a user selecting another tab is necessarily no longer viewing the spotlit or followed user.

In some implementations, the tabs 541, 542 may instead reflect the tabs that the video conference participants are currently collaborating over. In other words, the tabs 541, 542 may be synthetic tabs that differ from the tabs that are visible in the web browser UI of the participating client devices. For example, considering a video conference with 3 participants. Participant A is on web page A and has 5 tabs open. Participant B is also on web page A and has 10 tabs open. Participant C is on web page C and has 15 tabs open. In the context of the collaborative web browsing session 401, only two tabs 541, 542 may be shown, reflecting the fact that the 3 participants are browsing a total of 2 web pages, irrespective of the number of tabs that the individual participants have open. These two example implementations are intended to be non-limiting descriptions of how tabs 541, 542 may be used during the collaborative web browsing session 401, and other implementations are possible.

In an example collaborative interaction, the client device 408 receives an indication of the actions of another client device such as moving the mouse or selecting a tab. A representation of that action is shown on the browser UI 510. The client device 408 then receives another indication of another action of the other client device such as moving the mouse to a new location or selecting a different tab. The representation is updated based on the change or action. For example, the mouse position indicator 550 may move from a first location to a section location. Or a tab indicator 540 may move from a first tab to a second tab. UI 500 features such as mouse position indicator 550 may be shown only for followed or spotlit users, or they may be shown for all collaborating client devices.

Turning next to FIG. 6, FIG. 6 shows another illustration of a UI 600 of a web browser application for collaborative web browsing during video conferences, according to some aspects of the present disclosure. UI 600 depicts a collaborative web browsing session 401 including 2 spotlit client devices. The UI 600 again includes a main browsing window 510. Participant list 535 now indicates that two users are spotlit. Participant list 535 includes spotlight indications 605 and 610 for spotlit client devices 609 and 614, respectively. Spotlit client devices 609 and 614 are also highlighted as seen by the bolded or highlighted circle surrounding the representation of the users. In some examples, spotlight indications 605 and 610 can also function as buttons to disable or “un-spotlight” the spotlit client devices 609 and 614.

Spotlit user 609 is shown as a spotlit participant 608 among the participants 520. The spotlit participant 608 is labeled with spotlight indicator 607. The spotlit participant 608 shows a miniaturized depiction of the web browser UI 620 of the spotlit user 609. In this example, the miniaturized depiction of the web browser UI 620 is the web browser UI shown in FIG. 5. The spotlit participant 608 can show the content and interactions of the web browser UI 620 of the spotlit user 609. Because the depiction in spotlit participant 608 is miniaturized, some visual details may not be displayed. For example, the spotlit participant 608 may not show the mouse cursor location or may only show an “iconized” version of what the spotlit user 609 is viewing.

The web browser UI of spotlit user 614 is shown in the main browsing window 510. The spotlight indicator 612 is shown at the top of the main browsing windows, similarly to the following indicator 545. In this example, the mouse cursor indicator 615 associated with the spotlit user 614 shown the current mouse position of the spotlit user 614 in real-time. Other UI controls and indications may be similarly associated with indicators. In some examples, the user of the client device displaying the spotlit user 614 can interact with the web page independently of the spotlit user 614. In some examples, the spotlit user 614 can see reciprocal indicators of the web browsing actions of the users viewing the web browser UI of the spotlit user 614.

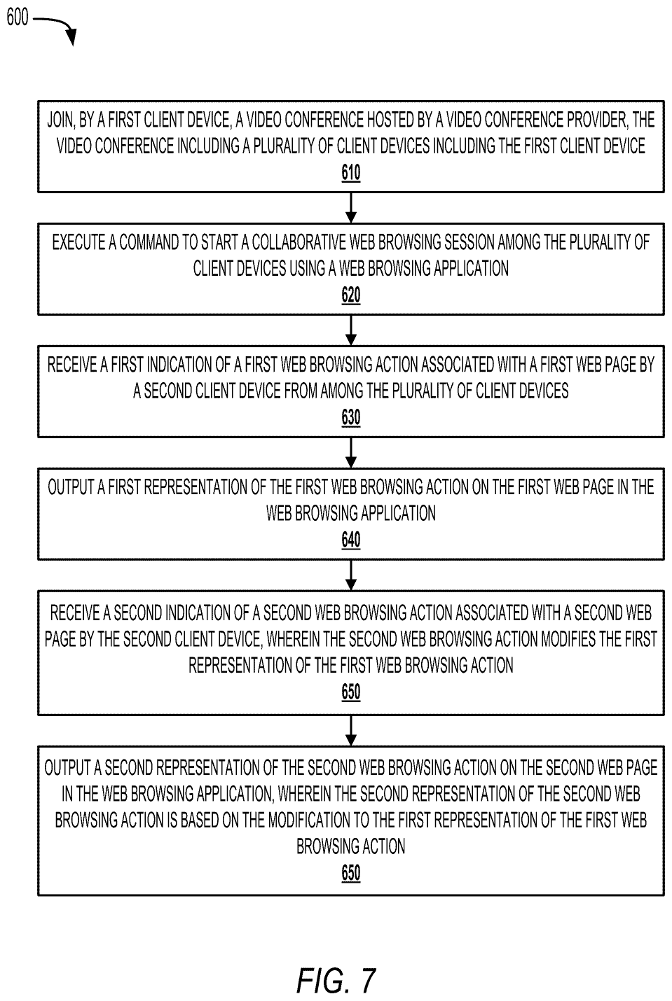

Referring now to FIG. 7, FIG. 7 shows a flowchart of an example method 700 for collaborative web browsing during video conferences, according to some aspects of the present disclosure. The description of the method 700 in FIG. 7 will be made with reference to FIGS. 4-7, however any suitable system according to this disclosure may be used, such as the example systems 100 and 200, shown in FIGS. 1 and 2. It should be appreciated that method 700 provides a particular method for providing techniques for collaborative web browsing during video conferences. Other sequences of operations may also be performed according to alternative examples. For example, alternative examples of the present disclosure may perform the steps outlined above in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the perspective of a client device 408 but other configurations are possible. One of ordinary skill in the art would recognize many variations, modifications, and alternatives.

The method 700 may include block 710. At block 710, a first client device joins a video conference hosted by a video conference provider, in which the video conference includes a number of client devices including the first client device. For example, the first client device may used by a participant that is a member of a collaborating team. The first client device may be the initiator the video conference or may join an in-progress video conference upon receipt of an invitation or via another mechanism.

At block 720, the first client device executes a command to start a collaborative web browsing session among the number of client devices using a web browsing application. For example, the UI of the video conference client software may provide a UI control or other mechanism to initiate a collaborative web browsing session 401 as described with respect to FIG. 4. The first client device may be, for example, used by a participant leading a collaborative effort that can benefit from collaborative co-browsing during the video conference.

Upon initiation of the collaborative web browsing session 401, the user of the first client device may see a UI displayed such as the example shown in FIG. 5. Included in the displayed UI may be a representation of the other client devices participating in the collaborative web browsing session 401. The other client devices may be shown using a variety of UI elements and controls. For example, other client devices may be represented by icons or profile pictures, which may also include names or other identifiers (e.g., location or IP address) displayed beneath or beside the icons. Other examples may include status indicators, cursors or pointers colored or shaped to identify each client device, participant lists such as participant panel 535, chat windows, activity indicators, and so on.

At block 730, the first client device receives a first indication of a first web browsing action associated with a first web page by a second client device from among the number of client devices. For example, the first client device may receive a data structure from the video conference provider 402 including information about the first web browsing action. The web browsing action may be, for example, a mouse movement or click, a tab selection, a window scroll action, entry of a URL, a bookmark selection, back or forward navigation, refresh or reload command, or text selection, among others.

In some examples, only a subset of all possible web browser actions may be output to the other client devices. This may be done to protect the privacy of the second client device or to conserve network bandwidth. For example, if a user switches to another application or rapidly moves the mouse, these actions may be screened from the information output to the first client device.

At block 740, the first client device outputs a first representation of the first web browsing action on the first web page in the web browsing application. For example, upon receipt of the information about the first web browsing action, the first client device may render a representation of the first web browsing action such that the first web browsing action appears on the display of the first client device. For instance, if the user of the second client device moves the mouse from a first point to a second point, a representation of the mouse cursor of the second client device at the second point may be shown on the display of the first client device.

At block 750, the first client device receives a second indication of a second web browsing action associated with a second web page by the second client device, in which the second web browsing action modifies the first representation of the first web browsing action. In some examples, the first web page and the second web page are the same. Thus, the web browsing actions described herein may take place on a single web page or may involve a transition from a first web page to a second web page (e.g., following a selection or clicking or a link).

For example, the first client device may receive another data structure from the video conference provider 402 including information about the second web browsing action. The second web browsing action can be a continuation of the first web browsing action. For instance, if the first web browsing action is a mouse movement to a link on a first web page, then the second web browsing action may be the clicking of that link, still on the same web page.

At block 770, the first client device outputs a second representation of the second web browsing action on the second web page in the web browsing application, in which the second representation of the second web browsing action is based on the modification to the first representation of the first web browsing action. For example, if the first web browsing action is a mouse movement to a link and the second web browsing action is the clicking of that link, then the second representation may include a click action (e.g., the link may change color or the mouse cursor may slightly depress) or a web browser to another web page.

In some examples, the web browsing actions of the second client device involve distinct first and second web pages. In these cases, the behavior of the output second representation may vary depending on the particular mode of the web browser UI of the first client device and may, in some cases, be configurable. Continuing the example above, following a page load of a second web page, the next web browsing action of the second client device may be mouse movement on a second, different web page. If the second client device is spotlit or being followed, them the output second representation may include a transition to the second web page. If the second client device is not being spotlit or being followed, then the output representation may include actions such as showing an indication of an opening a new tab containing the second web page, updating a tab indication to show the second client device on the second web page, or showing an indicator such as an arrow or banner to indicate that the second client device is on the second web page.

In some examples, the first client device can output a notification including information about the first web browsing action and the second web browsing action. The notification may include information about web browsing actions such as initiation or stopping of the collaborative web browsing session, following, unfollowing, spotlighting, stopping of spotlighting, mouse movements and clicks, tab changes, and so on. The notification may be sent over any suitable medium including via desktop or browser notification, smartphone push notification, email, text message, and so on.

Notifications may be sent as part of the collaborative web browsing session 401 to enhance the functionality of the collaborative web browsing during video conferences features. For example, a notification may be associated with a potentially malicious web browsing action or other security risk. Notifications may be generated, during collaborative web browsing, to alert participants to network connectivity issues that may affect the collaborative web browsing experience. Notifications may be associated with permissions, privacy, confidentiality, or encryption changes as they relate to collaborative web browsing. In some examples, notifications may be generated when particular documents or other content are modified during a collaborative web browsing session 401. In some examples, notifications may be generated to indicate the initiation or stopping of the collaborative web browsing session 401, similar to notifications issued during the starting or stopping of video conference recording.

Collaborative web browsing may involve conflicts. In a simple example, two followed or spotlit users browsing the same web page may take an action that leads to another web page, such as clicking a link. A more complex example may involve two or more followed or spotlit users attempting to edit the same field or piece of text at the same time. These and similar scenarios can be addressed with a robust deconfliction policy. For example, conflicts can be resolved in favor of the user who was followed or spotlit first. Other conflict resolution mechanisms may involve locking UI controls or enabling simultaneous operation of UI controls using, for example, multiple colors. In some examples, the conflict resolution mechanism may be configured by the host of the video conference.

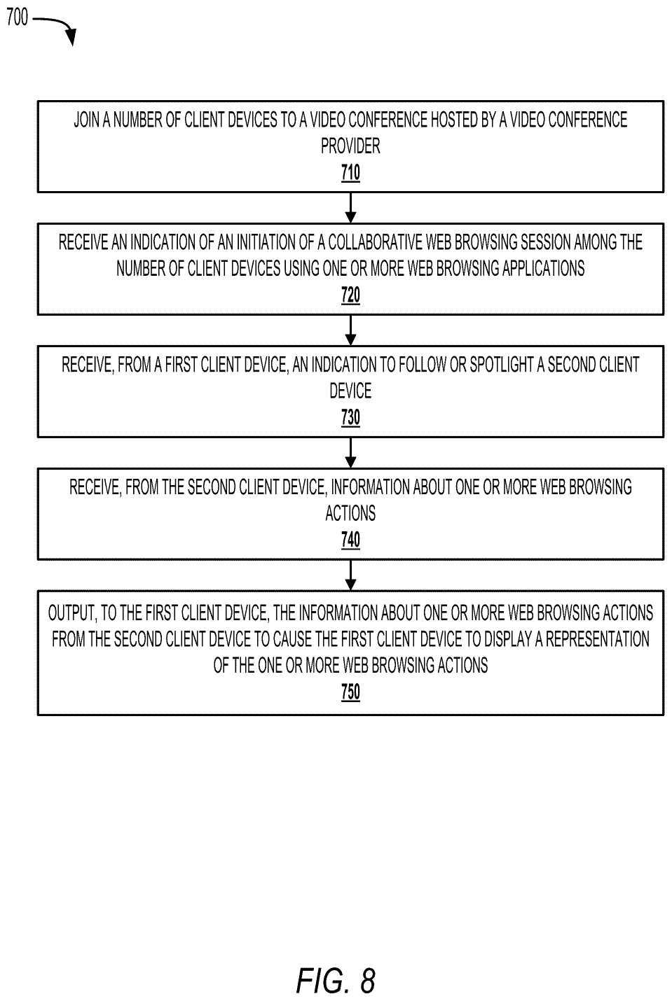

Referring now to FIG. 8, FIG. 8 shows a flowchart of another example method 800 for collaborative web browsing during video conferences. The description of the method 800 in FIG. 8 will be made with reference to FIGS. 4-8, however any suitable system according to this disclosure may be used, such as the example systems 100 and 200, shown in FIGS. 1 and 2. It should be appreciated that method 800 provides a particular method for providing techniques for collaborative web browsing during video conferences. Other sequences of operations may also be performed according to alternative examples. For example, alternative examples of the present disclosure may perform the steps outlined above in a different order. Moreover, the individual operations illustrated by method 800 may include multiple sub-operations that may be performed in various sequences as appropriate to the individual operation. Furthermore, additional operations may be added or removed depending on the particular applications. Further, the operations described in method 800 may be performed by different devices. For example, the description is given from the perspective of a video conference provider 402 but other configurations are possible. One of ordinary skill in the art would recognize many variations, modifications, and alternatives.

The method 800 may include block 810. At block 810, a computing device joins a number of client devices 408, 410, 412 to a video conference hosted by a video conference provider 402. For example, one client device 408 may initiate the video conference, acting as the host for the video conference. The other client devices 410, 412 can then be invited to the video conference using a suitable mechanism such as via link sent by email, notification, chat, etc. The video conference provider 402 then joins the other client devices 410, 412 to the in-progress video conference.

At block 820, the computing device receives an indication of an initiation of a collaborative web browsing session among the number of client devices using one or more web browsing applications. For example, the client devices 408, 410, 412 may be used or operated by users that desire to collaborate using a web browser application such as a mobile browser, desktop browser, or embedded browser client provided by the video conference client software. One user, the host or another user leading or initiating a collaboration effort, may operate a UI control to cause an indication to be output to the video conference provider to initiate a collaboration web browsing session 401. For example, the UI may provide a “Start Collaboration” button or other similar control to indicate an initiation of a collaborative web browsing session 401 from within an embedded web browser provided by the video conference client software. In another example, a web browser external to the video conference client software (e.g., a desktop browser) may include a plugin or integration that includes controls or commands for initiating a collaborative web browsing session 401 within the context of the video conference. The collaboration web browsing session 401 may be established using protocols suitable for real-time and continuous exchange of data such as WebSocket or WebRTC. These protocols can allow the collaborating client devices to exchange messages and data bidirectionally with low latency using the video conference provider 402 to facilitate the exchange of information.

At block 830, the computing device receives, from a first client device, an indication to follow or spotlight a second client device. For example, during the collaboration web browsing session 401, the first client device may desire to follow or spotlight a second client device. Both following or spotlighting the second client device may involve seeing the web browsing actions of the second client device on the display of the first client device. In some examples, following or spotlighting may result in the web browser of the first client device being completely or partially occluded by a representation or facsimile of the web browser of the second client device. An example of a client device following another client device is depicted in FIG. 5 and the accompanying description.

Following or spotlighting can be distinguished by which user initiates the following or spotlighting or where the following or spotlighting causes an output. For example, a first client device can follow a second client device, which can cause the display of the first client device to display a representation or facsimile of the web browser of the second client device. On the other hand, a first client device can spotlight a second client device, which can cause the display of all client devices participating in the video conference to display a representation or facsimile of the web browser of the second client device.

At block 840, the computing device receives, from the second client device, information about one or more web browsing actions. For example, the second client device may output indications of mouse movements, tab changes, link clicks, file downloads, and so on. The second client device can output information about these web browsing actions in a suitable data structure to the video conference provider 402.

At block 850, the computing device outputs, to the first client device, the information about one or more web browsing actions from the second client device to cause the first client device to display a representation of the one or more web browsing actions. For example, the video conference provider 402, in receipt of the data structure including the information about the one or more web browsing actions of the second client device, can output the information about the one or more web browsing actions of the second client device to the first client device. In some examples, the video conference provider 402 may construct a second data structure that includes the information about the one or more web browsing actions of the second client device in a format suitable for consumption by the first client device.

Upon receipt of the information about the one or more web browsing actions of the second client device, the first client device can display a representation of the one or more web browsing actions. For example, the first client device may render the one or more web browsing actions of the second client device so as to show a representation or facsimile of the web browser of the second client device on the display of the first client device.

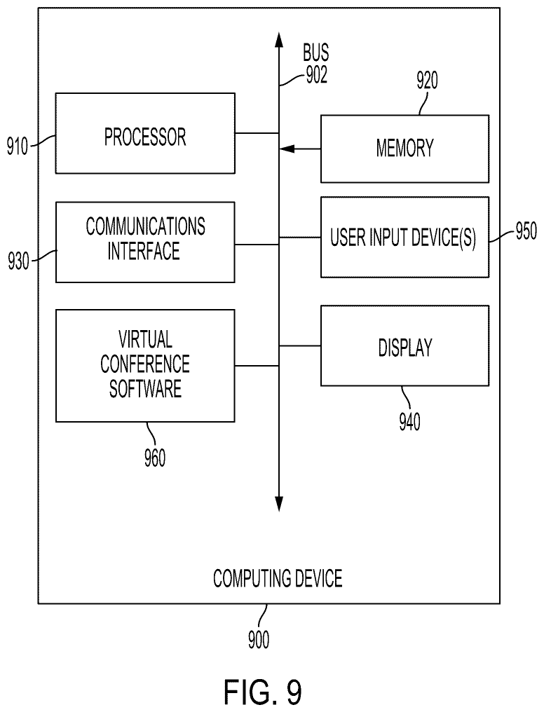

Referring now to FIG. 9, FIG. 9 shows an example computing device 900 suitable for use in example systems or methods for providing collaborative web browsing during video conferences according to this disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for collaborative web browsing during video conferences according to different examples, such as part or all of the example methods 600 and 700 described above with respect to FIGS. 6 and 7. The computing device 900, in this example, also includes one or more user input devices 950, such as a keyboard, mouse, touchscreen, microphone, etc., to accept user input. The computing device 900 also includes a display 940 to provide visual output to a user.

In addition, the computing device 900 includes virtual conferencing software 960 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method, comprising: joining, by a first client device, a video conference hosted by a video conference provider, the video conference including a plurality of client devices including the first client device; executing a command to start a collaborative web browsing session among the plurality of client devices using a web browsing application; receiving a first indication of a first web browsing action associated with a first web page by a second client device from among the plurality of client devices; outputting a first representation of the first web browsing action on the first web page in the web browsing application; receiving a second indication of a second web browsing action associated with a second web page by the second client device, wherein the second web browsing action modifies the first representation of the first web browsing action; and outputting a second representation of the second web browsing action on the second web page in the web browsing application, wherein the second representation of the second web browsing action is based on the modification to the first representation of the first web browsing action.

Example 2 is the method of example(s) 1, wherein the web browsing application is an embedded web browser application associated with video conference client software executing on the plurality of the client devices.

Example 3 is the method of example(s) 1, wherein: the first web browsing action is a first selection of a first web browser tab; and the second web browsing action is a second selection of a second web browser tab.

Example 4 is the method of example(s) 3, wherein the first representation is an icon displayed on the first web browser tab, the icon representing the second client device.

Example 5 is the method of example(s) 1, wherein the first web page and the second web page are the same web page.

Example 6 is the method of example(s) 1, wherein: the first web browsing action is a first cursor movement traversing the first web page; and the second web browsing action is a second cursor movement traversing the second web page.

Example 7 is the method of example(s) 1, wherein the first representation of the first web browsing action on the first web page includes a representation of the second client device, comprising at least one of: a label associated with the second client device, a color associated with the second client device, or a notification that the first client device is following the second client device.

Example 8 is the method of example(s) 1, wherein: the first web browsing action is a first selection of a first control to follow the first client device; and the second web browsing action is a second selection of a second control to unfollow the first client device.

Example 9 is the method of example(s) 1, further comprising: outputting, to the second client device, a third indication of a third web browsing action associated with a third web page by the first client device.

Example 10 is the method of example(s) 1, further comprising: outputting a notification including information about the first web browsing action and the second web browsing action.

Example 11 is the method of example(s) 1, further comprising receiving a third indication of a selection of the second client device.

Example 12 is the method of example(s) 11, wherein the selection corresponds to a spotlight mode.

Example 13 is the method of example(s) 11, wherein the selection corresponds to a follow mode.

Example 14 is a non-transitory computer-readable medium storing instructions that, when executed by one or more processors, cause the one or more processors to perform operations including: joining, by a first client device, a video conference hosted by a video conference provider, the video conference including a plurality of client devices including the first client device; executing a command to start a collaborative web browsing session among the plurality of client devices using a web browsing application; receiving a first indication of a first web browsing action associated with a first web page by a second client device from among the plurality of client devices; outputting a first representation of the first web browsing action on the first web page in the web browsing application; receiving a second indication of a second web browsing action associated with a second web page by the second client device, wherein the second web browsing action modifies the first representation of the first web browsing action; and outputting a second representation of the second web browsing action on the second web page in the web browsing application, wherein the second representation of the second web browsing action is based on the modification to the first representation of the first web browsing action.

Example 15 is the non-transitory computer-readable medium of example(s) 14, wherein the web browsing application is an embedded web browser application associated with video conference client software executing on the plurality of the client devices.

Example 16 is the non-transitory computer-readable medium of example(s) 14, further comprising receiving a third indication of a selection of the second client device, wherein the selection corresponds to a spotlight mode or a follow mode.

Example 17 is a system comprising: one or more processors; and one or more computer-readable storage media storing instructions which, when executed by the one or more processors, cause the one or more processors to perform operations including: joining, by a first client device, a video conference hosted by a video conference provider, the video conference including a plurality of client devices including the first client device; executing a command to start a collaborative web browsing session among the plurality of client devices using a web browsing application; receiving a first indication of a first web browsing action associated with a first web page by a second client device from among the plurality of client devices; outputting a first representation of the first web browsing action on the first web page in the web browsing application; receiving a second indication of a second web browsing action associated with a second web page by the second client device, wherein the second web browsing action modifies the first representation of the first web browsing action; and outputting a second representation of the second web browsing action on the second web page in the web browsing application, wherein the second representation of the second web browsing action is based on the modification to the first representation of the first web browsing action.

Example 18 is the system of example(s) 17, wherein the web browsing application is an embedded web browser application associated with video conference client software executing on the plurality of the client devices.

Example 19 is the system of example(s) 17, further comprising receiving a third indication of a selection of the second client device, wherein the selection corresponds to a spotlight mode or a follow mode.

Example 20 is the system of example(s) 17, wherein: the first web browsing action is a first cursor movement traversing the first web page; the second web browsing action is a second cursor movement traversing the second web page; and the first representation of the first web browsing action on the first web page includes a representation of the second client device, comprising at least one of: a label associated with the second client device, a color associated with the second client device, or a notification that the first client device is following the second client device.

That which is claimed is:

1. A method, comprising:
joining, by a first client device, a video conference hosted by a video conference provider, the video conference including a plurality of client devices including the first client device;
executing a command to start a collaborative web browsing session among the plurality of client devices using a web browsing application;
receiving a first indication of a first web browsing action associated with a first web page by a second client device from among the plurality of client devices;
outputting a first representation of the first web browsing action on the first web page in the web browsing application;
receiving a second indication of a second web browsing action associated with a second web page by the second client device, wherein the second web browsing action modifies the first representation of the first web browsing action; and
outputting a second representation of the second web browsing action on the second web page in the web browsing application, wherein the second representation of the second web browsing action is based on the modification to the first representation of the first web browsing action.

2. The method of claim 1, wherein the web browsing application is an embedded web browser application associated with video conference client software executing on the plurality of the client devices.

3. The method of claim 1, wherein:
the first web browsing action is a first selection of a first web browser tab; and
the second web browsing action is a second selection of a second web browser tab.

4. The method of claim 3, wherein the first representation is an icon displayed on the first web browser tab, the icon representing the second client device.

5. The method of claim 1, wherein the first web page and the second web page are the same web page.

6. The method of claim 1, wherein:
the first web browsing action is a first cursor movement traversing the first web page; and
the second web browsing action is a second cursor movement traversing the second web page.

7. The method of claim 1, wherein the first representation of the first web browsing action on the first web page includes a representation of the second client device, comprising at least one of: a label associated with the second client device, a color associated with the second client device, or a notification that the first client device is following the second client device.

8. The method of claim 1, wherein:
the first web browsing action is a first selection of a first control to follow the first client device; and
the second web browsing action is a second selection of a second control to unfollow the first client device.

9. The method of claim 1, further comprising:
outputting, to the second client device, a third indication of a third web browsing action associated with a third web page by the first client device.

10. The method of claim 1, further comprising:
outputting a notification including information about the first web browsing action and the second web browsing action.

11. The method of claim 1, further comprising receiving a third indication of a selection of the second client device.

12. The method of claim 11, wherein the selection corresponds to a spotlight mode.

13. The method of claim 11, wherein the selection corresponds to a follow mode.

14. A non-transitory computer-readable medium storing instructions that, when executed by one or more processors, cause the one or more processors to perform operations including:
joining, by a first client device, a video conference hosted by a video conference provider, the video conference including a plurality of client devices including the first client device;
executing a command to start a collaborative web browsing session among the plurality of client devices using a web browsing application;
receiving a first indication of a first web browsing action associated with a first web page by a second client device from among the plurality of client devices;
outputting a first representation of the first web browsing action on the first web page in the web browsing application;
receiving a second indication of a second web browsing action associated with a second web page by the second client device, wherein the second web browsing action modifies the first representation of the first web browsing action; and
outputting a second representation of the second web browsing action on the second web page in the web browsing application, wherein the second representation of the second web browsing action is based on the modification to the first representation of the first web browsing action.

15. The non-transitory computer-readable medium of claim 14, wherein the web browsing application is an embedded web browser application associated with video conference client software executing on the plurality of the client devices.

16. The non-transitory computer-readable medium of claim 14, further comprising receiving a third indication of a selection of the second client device, wherein the selection corresponds to a spotlight mode or a follow mode.

17. A system comprising:
one or more processors; and
one or more computer-readable storage media storing instructions which, when executed by the one or more processors, cause the one or more processors to perform operations including:
joining, by a first client device, a video conference hosted by a video conference provider, the video conference including a plurality of client devices including the first client device;
executing a command to start a collaborative web browsing session among the plurality of client devices using a web browsing application;
receiving a first indication of a first web browsing action associated with a first web page by a second client device from among the plurality of client devices;
outputting a first representation of the first web browsing action on the first web page in the web browsing application;
receiving a second indication of a second web browsing action associated with a second web page by the second client device, wherein the second web browsing action modifies the first representation of the first web browsing action; and
outputting a second representation of the second web browsing action on the second web page in the web browsing application, wherein the second representation of the second web browsing action is based on the modification to the first representation of the first web browsing action.

18. The system of claim 17, wherein the web browsing application is an embedded web browser application associated with video conference client software executing on the plurality of the client devices.

19. The system of claim 17, further comprising receiving a third indication of a selection of the second client device, wherein the selection corresponds to a spotlight mode or a follow mode.

20. The system of claim 17, wherein:
the first web browsing action is a first cursor movement traversing the first web page;
the second web browsing action is a second cursor movement traversing the second web page; and
the first representation of the first web browsing action on the first web page includes a representation of the second client device, comprising at least one of: a label associated with the second client device, a color associated with the second client device, or a notification that the first client device is following the second client device.
